(19) United States
(12) Patent Application Publication
(10) Pub. No.: US 2019/0072814 A1
(43) Pub. Date: Mar. 7, 2019

(54) DISPLAY DEVICE AND METHOD OF MANUFACTURING THE SAME

(71) Applicant: Samsung Display Co., Ltd., Yongin-si (KR)

(72) Inventors: Yeun Tae KIM, Hwaseong-si (KR); Min Wook PARK, Asan-si (KR); Sang II PARK, Seoul (KR); Jun Bo SIM, Asan-si (KR); Jin Su LEE, Suwon-si (KR)

(21) Appl. No.: 16/119,070

(22) Filed: Aug. 31, 2018

(30) Foreign Application Priority Data
Sep. 4, 2017 (KR) 10-2017-0112833

(51) Int. Cl. G02F 1/1335; G02F 1/1333; G02F 1/1339

(52) U.S. Cl. CPC G02F 1/133514; G02F 2202/02; G02F 1/1339; G02F 1/133305

(57) ABSTRACT

A display device and a method for manufacturing the display device are provided. According to an exemplary embodiment, a display device includes: a first substrate on which a display area and a non-display area disposed outside the display area are defined; a second substrate facing the first substrate; a liquid crystal layer disposed between the first and second substrates; a first color filter disposed in the non-display area; a second color filter disposed on the first color filter; a first organic film disposed on the second color filter; and a seal pattern formed on the first organic film and overlapping with at least one of the first and second color filters.

### CROSS REFERENCE TO RELATED APPLICATION

This application claims priority from and the benefit of Korean Patent Application No. 10-2017-0112833, filed on Sep. 4, 2017, which is hereby incorporated by reference for all purposes as if fully set forth herein.

### BACKGROUND

### Field

Exemplary embodiments of the invention relate to a display device and a method of manufacturing the same.

### Discussion of the Background

The importance of display devices has steadily grown with recent developments in multimedia technology. Accordingly, a variety of display devices such as a liquid crystal display (LCD) device, an organic light-emitting diode (OLED) display device, and the like have been widely used.

A display device includes various elements that are stacked on a substrate in a complicated manner. In this case, height differences between the elements may be formed in the display device. These height differences may cause irregularities on the display device non-uniform display quality.

The above information disclosed in this Background section is only for understanding of the background of the inventive concepts, and, therefore, it may contain information that does not form prior art.

### SUMMARY

Exemplary embodiments provide a display device with a uniform display quality.

Exemplary embodiments also provide a method of manufacturing a display device, which can uniformly inject liquid crystal molecules.

However, exemplary embodiments are not restricted to those set forth herein. The above and other exemplary embodiments of the invention will become more apparent to one of ordinary skill in the art to which the present disclosure pertains by referencing the detailed description of the invention given below.

According to an exemplary embodiment, a display device includes: a first substrate on which a display area and a non-display area disposed outside the display area are defined; a second substrate facing the first substrate; a liquid crystal layer disposed between the first and second substrates; a first color filter disposed in the non-display area; a second color filter disposed on the first color filter; a first organic film disposed on the second color filter; and a seal pattern formed on the first organic film and overlapping with at least one of the first and second color filters.

The display device may further include a second organic film formed on the first organic film and comprising a colored pigment.

The seal pattern may overlap with the second organic film.

A first point may be defined where the second organic film, the first organic film, and the second color filter overlap with one another on the inside of the seal pattern. A second point may be defined where the second organic film, the first organic film, the second color filter, and the first color filter overlap with one another on the inside of the seal pattern. A third point may be defined where the first organic film, the second color filter, and the first color filter overlap with one another on the inside of the seal pattern.

A first height may be defined as the distance between the first point and the top of the liquid crystal layer. A second height may be defined as the distance between the second point and the top of the liquid crystal layer. A third height, may be defined as the distance between the third point and the top of the liquid crystal layer. A difference between a maximum and a minimum among the first, second, and third heights may be 0.2 μm or less.

The first, second, and third heights may all be the same.

The seal pattern may overlap with the first and second color filters.

A first point and a second point are defined as where the first color filter, the second color filter, and the first organic film overlap with one another on the inside of the seal pattern. A difference between a first height, which may be the distance between the first point and the top of the liquid crystal layer, and a second height, which may be the distance between the second point and the top of the liquid crystal layer, may be 0.2 μm or less.

The first height may be the same as the second height.

The first color filter may be a red color filter, and the second color filter may be a blue color filter.

The first color filter may be a blue color filter, and the second color filter may be a red color filter.

The first color filter, the second color filter, the first organic film, and the seal pattern may be formed at a corner area of the non-display area.

According to another exemplary embodiment, a method of manufacturing a display device includes: forming a first color filter in a non-display area of a first substrate on which a display area and the non-display area are defined; forming a second color filter on the first color filter; forming a first organic film on the second color filter; forming a seal pattern on the first organic film; and bonding the first substrate and a second substrate that faces the first substrate, wherein the seal pattern overlaps with at least one of the first and second color filters.

The method may further include forming a second organic film, which comprises a colored pigment, on the first organic film.

The seal pattern may overlap with the second organic film.

A first point may be defined as where the second organic film, the first organic film, and the second color filter overlap with one another on the inside of the seal pattern. A second point may be defined as where the second organic film, the first organic film, the second color filter, and the first color filter overlap with one another on the inside of the seal pattern. A third point may be defined as where the first organic film, the second color filter, and the first color filter may overlap with one another on the inside of the seal pattern.

A liquid crystal layer may be disposed between the first and second substrates. A first height may be defined as the distance between the first point and the top of the liquid crystal layer. A second height may be defined as the distance between the second point and the top of the liquid crystal layer. A third height may be defined as the distance between the third point and the top of the liquid crystal layer. A difference between a maximum and a minimum among the first, second, and third heights may be 0.2 μm or less.

The first, second, and third heights may all be the same.

The first color filter may be a red color filter, and the second color filter may be a blue color filter.

The first color filter may be a blue color filter, and the second color filter may be a red color filter.

According to the aforementioned and other exemplary embodiments of the invention, a display device with a uniform display quality can be provided.

Additional features of the inventive concepts will be set forth in the description which follows, and in part will be apparent from the description, or may be learned by practice of the inventive concepts.

It is to be understood that both the foregoing general description and the following detailed description are exemplary and explanatory and are intended to provide further explanation of the invention as claimed

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a layout view of a display device according to an exemplary embodiment of the invention.

FIG. 2 is an enlarged view of an area A of FIG. 1.

FIG. 3 is a cross-sectional view taken along line I-I′ of FIG. 2.

FIG. 4 is a cross-sectional view taken along line II-II′ of FIG. 1.

FIG. 5 is a cross-sectional view of a display device according to another exemplary embodiment.

FIG. 6 is a cross-sectional view of a display device according to another exemplary embodiment.

FIG. 7 is a cross-sectional view illustrating a method of manufacturing a display device according to an exemplary embodiment.

FIG. 8 is a cross-sectional view illustrating the method of manufacturing a display device according to an exemplary embodiment.

FIG. 9 is a cross-sectional view illustrating a method of manufacturing a display device according to an exemplary embodiment.

FIG. 10 is a cross-sectional view illustrating a method of manufacturing a display device according to an exemplary embodiment.

FIG. 11 is a cross-sectional view illustrating a method of manufacturing a display device according to an exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the inventive concepts.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, exemplary embodiments of the present invention will be described with reference to the attached drawings.

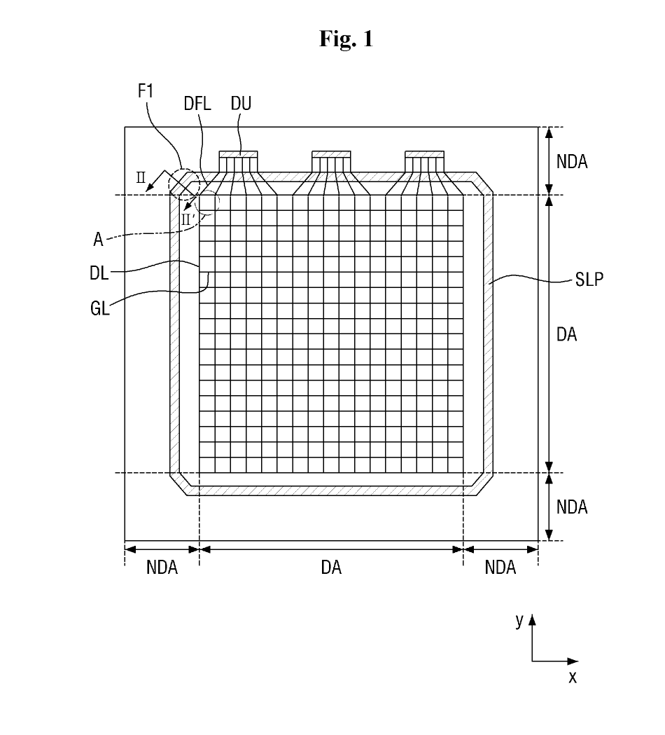

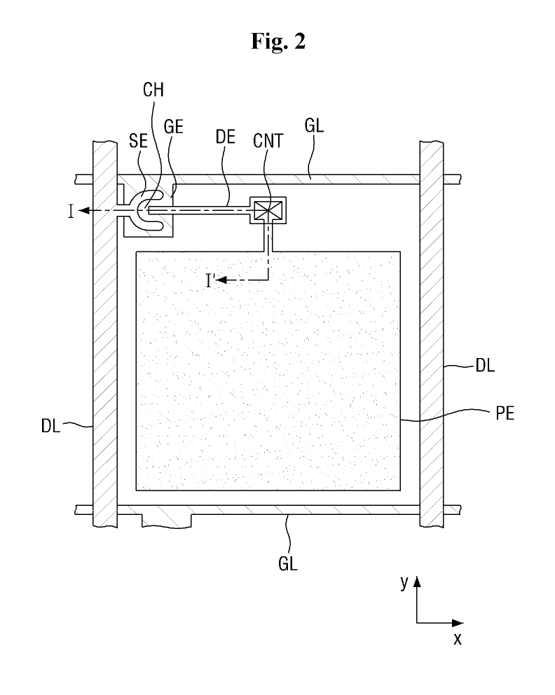

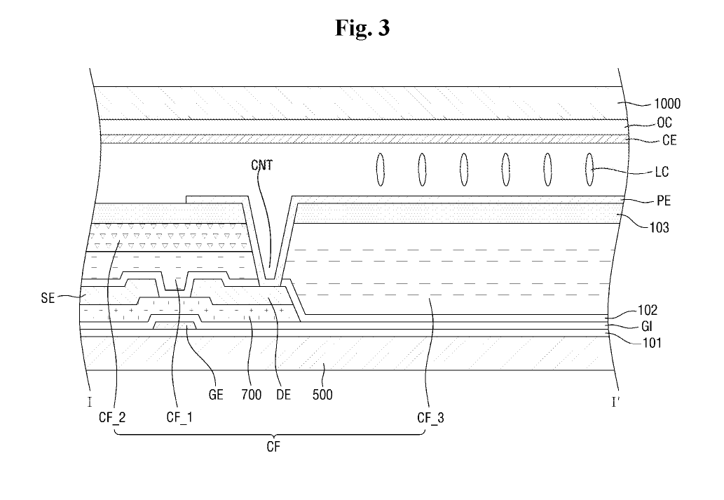

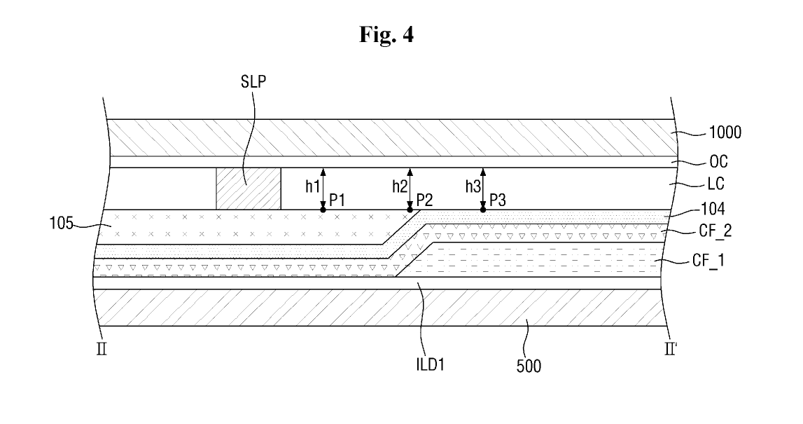

FIG. 1 is a layout view of a display device according to an exemplary embodiment. FIG. 2 is an enlarged view of an area A of FIG. 1. FIG. 3 is a cross-sectional view taken along line I-I′ of FIG. 2. FIG. 4 is a cross-sectional view taken along line II-II′ of FIG. 1.

Referring to FIGS. 1 through 4, the display device includes a first substrate 500, which has a display area DA and a non-display area NDA disposed outside the display area DA, a first color filter CF_1, which is disposed in the non-display area NDA, a second color filter CF_2, which is disposed on the first color filter CF_1, a first organic film 104, which is disposed on the second color filter CF_2, and a seal pattern SLP, which is formed on the first organic film 104 and overlaps with at least one of the first and second color filters CF_1 and CF_2.

The first substrate 500 may be formed of a material having heat resistance and transparency. The first substrate 500 may be formed of, for example, transparent glass or plastic, but the present disclosure is not limited thereto. The display area DA and the non-display area NDA may be defined on the first substrate 500.

The display area DA is an area in which an image is displayed by the display device and the non-display area NDA is an area in which various signal lines are arranged in order to display an image in the display area DA.

A plurality of data drivers DU may be disposed on the non-display area NDA. The plurality of data drivers DW may provide a data signal to a plurality of data lines DL and a plurality of data fan-out lines DFL. The plurality of data fan-out lines DFL may transmit the data signal provided by the data drivers DU to the data lines DL.

Specifically, a plurality of pixels, which are defined by the data lines DL and a plurality of gate lines GL intersecting the data lines DL, may be disposed on the display area DA. FIG. 2 illustrates a single pixel in the area A of FIG. 1, and the display area DA may include a plurality of pixels that are substantially the same as the pixel illustrated in FIG. 2.

Referring to FIG. 3, a buffer layer 101 may be disposed on the first substrate 500 in an exemplary embodiment. For example, the buffer layer 101 may comprise an inorganic insulating material. For example, the buffer layer 101 may comprise at least one selected from the group consisting of silicon oxide, silicon nitride, silicon oxynitride, aluminum oxynitride, titanium oxynitride, zirconium oxynitride, hafnium oxynitride, tantalum oxynitride, and tungsten oxynitride.

In another exemplary embodiment, the buffer layer 101 may not be provided. In this exemplary embodiment, gate wiring GL and GE, which will be described later, may be placed in contact with the first substrate 500.

The gate wiring GL and GE may be disposed on the buffer layer 101.

The gate wiring GL and GE may include a gate line GL, which receives a signal for driving the display device, and a gate electrode GE, which protrudes from the gate line GL in the form of a protrusion. The gate line GL may extend in a first direction. The first direction may be the same as, for example, an x-axis direction of FIG. 2. The gate electrode GE may form the three terminals of a thin film transistor (TFT) together with a source electrode SE and a drain electrode DE, which will be described later.

The gate wiring GL and GE may comprise at least one of an aluminum (Al)-based metal including an Al alloy, a silver (Ag)-based metal including an Ag alloy, a copper (Cu)-based metal including a Cu alloy, a molybdenum (Mo)-based metal including a Mo alloy, chromium (Cr), titanium (Ti), and tantalum (Ta), but the material of the gate wiring GL and GE is not particularly limited. That is, various metals or polymer materials having a performance that is required to realize a desired display device may be used as the material of the gate wiring GL and GE.

The gate wiring GL and GE may have a single-layer structure, but the present disclosure is not limited thereto. Alternatively, the gate wiring GL and GE may have a double-, triple-, or multiple-layer structure.

A gate insulating film GI may be disposed on the gate wiring GL and GE. The gate insulating film GI may be formed on the entire surface of the first substrate 500 to cover the gate wiring GL and GE.

The gate insulating film GI may be formed by mixing at least one selected from the group consisting of an inorganic insulating material, such as silicon oxide (SiOx), silicon nitride (SiNx), benzocyclobutene (BCB), an acrylic material, and an organic insulating material, such as polyimide (PI), but the gate insulating film GI is not particularly limited to these materials.

A semiconductor pattern layer 700 may be disposed on the gate insulating film GI.

The semiconductor pattern layer 700 may comprise amorphous silicon or polycrystalline silicon, but the present disclosure is not limited thereto. Alternatively, the semiconductor pattern layer 700 may comprise an oxide semiconductor.

The semiconductor pattern layer 700 may have various shapes such as an island shape or a linear shape. In a case where the semiconductor pattern layer 700 has a linear shape, the semiconductor pattern layer 700 may be disposed below a data line DL and may extend to the top of the gate electrode GE.

In an exemplary embodiment, the semiconductor pattern layer 700 may be patterned into the same shape as data wiring (DL, SE, and DE), which will hereinafter be described, in an entire area except for a channel portion CH.

In other words, the semiconductor pattern layer 700 may be disposed to overlap with the data wiring (DL, SE, and DE) in the entire area except for the channel portion CH.

The channel portion CH may be disposed between the source electrode SE and the drain electrode DE, which face each other. The channel portion CH may electrically connect the source electrode SE and the drain electrode DE, and the shape of the channel portion CH is not particularly limited.

An ohmic contact layer (not illustrated), which is doped with a high concentration of n-type impurities, may be disposed on the semiconductor pattern layer 700. The ohmic contact layer may completely or partially overlap with the semiconductor pattern layer 700. In an exemplary embodiment where the semiconductor pattern layer 700 comprises an oxide semiconductor, the ohmic contact layer may not be provided.

In a case where the semiconductor pattern layer 700 comprises an oxide semiconductor, the semiconductor pattern layer 700 may comprise zinc oxide (ZnO). The semiconductor pattern layer 700 may be doped with ions of at least one selected from the group consisting of gallium (Ga), indium (In), stannum (Sn), zirconium (Zr), hafnium (Hf), cadmium (Cd), silver (Ag), copper (Cu), germanium (Ge), gadolinium (Gd), titanium (Ti), and vanadium (V). In an exemplary embodiment where the semiconductor pattern layer 700 comprises an oxide semiconductor, the semiconductor pattern layer 700 may comprise at least one selected from the group consisting of ZnO, ZnGaO, ZnInO, ZnSnO, GaInZnO, CdO, InO, GaO, SnO, AgO, CuO, GeO, GdO, HfO, TiZnO, InGaZnO, and InTiZnO, but the material of the semiconductor pattern layer 700 is not particularly limited.

The data wiring (DL, SE, and DE) may be disposed on the semiconductor pattern layer 700. The data wiring (DL, SE, and DE) may include the data line DL, the source electrode SE, and the drain electrode DE.

The data line DL may extend in a second direction, for example, a y-axis direction of FIG. 2, and may intersect the gate line GL. The source electrode SE may be branched off from the data line DL and may extend to the top of the semiconductor pattern layer 700.

The drain electrode DE may be spaced apart from the source electrode SE and may be arranged to face the source electrode SE over the semiconductor pattern layer 700 with the gate electrode GE or the channel portion CH disposed therebetween. The drain electrode DE may be placed in contact with, and electrically connected to, a pixel electrode PE, which will be described later.

The data wiring (DL, SE, and DE) may be formed of nickel (Ni), cobalt (Co), titanium (Ti), silver (Ag), copper (Cu), molybdenum (Mo), aluminum (Al), beryllium (Be), niobium (Nb), gold (Au), iron (Fe), selenium (Se), or tantalum (Ta) and may have a single- or multilayer structure. The data wiring (DL, SE, and DE) may also be formed of an alloy of at least one selected from the group consisting of titanium (Ti), zirconium (Zr), tungsten (W), tantalum (Ta), niobium (Nb), platinum (Pt), hafnium (Hf), oxygen (O), and nitrogen (N), but the material of the data wiring (DL, SE, DE) is not particularly limited.

FIG. 2 illustrates an example in which one TFT is disposed in each pixel, but the present disclosure is not limited thereto. That is, in another example, a plurality of TFTs may be disposed in each pixel. In a case where a plurality of TFTs are disposed in each pixel, each pixel may be divided into a plurality of domains.

A first passivation film 102 may be disposed on the gate insulating film GI and the data wiring (DL, SE, and DE).

In an exemplary embodiment, the first passivation film 102 may be formed of an inorganic insulating material. The first passivation film 102 may include an inorganic insulating material such as, for example, silicon oxide (SiOx), silicon nitride (SiNx), and silicon oxynitride (SiNOx).

A color filter layer CF may be disposed on the first passivation film 102.

In an exemplary embodiment, the color filter layer CF may include first, second, and third color filters CF_1, CF_2, and CF_3, which display a different color from one another.

In an exemplary embodiment, the first color filter CF_1 may be a red color filter, the second color filter CF_2 may be a blue color filter, and the third color filter CF_3 may be a green color filter.

For convenience, the first and second color filters CF_1 and CF_2 will hereinafter be described as being red and blue color filters, respectively, but the present disclosure is not limited thereto. Alternatively, the first and second color filters CF_1 and CF_2 may be blue and red color filters, respectively.

In an exemplary embodiment, each pixel may display one of red, blue, and green colors.

FIG. 3 illustrates an exemplary pixel that displays a green color.

In this case, the third color filter CF_3 may display a green color and may be formed to overlap with the pixel electrode PE.

The first and second color filters CF_1 and CF_2 may be disposed on the data wiring (DL, SE, and DE). The first and second color filters CF_1 and CF_2 may be sequentially stacked and may prevent light provided by a backlight unit (not illustrated) from leaking out to the data wiring (DL, SE, and DE). That is, the stack of the first and second color filters CF_1 and CF_2 may block the transmission of light therethrough. That is, the stack of the first and second color filters CF_1 and CF_2 may replace an existing black matrix.

A second passivation film 103 may be disposed on the color filter layer CF.

In an exemplary embodiment, the second passivation film 103 may be formed of an organic insulating material. The organic insulating material may comprise any one selected from among BCB, an acrylic material, and PI, but the material of the second passivation film 103 is not particularly limited.

The second passivation film 103 may cover the color filter layer CF.

The pixel electrode PE may be disposed on the second passivation film 103. The pixel electrode PE may penetrate the first passivation film 102, the color filter layer CF, and the second passivation film 103 and may be electrically connected to the drain electrode DE via a contact hole CNT, which at least partially exposes the drain electrode DE.

In an exemplary embodiment, the pixel electrode PE may be formed of a transparent conductive material such as indium tin oxide (ITO) or indium zinc oxide (IZO) or a reflective conductive material such as Al.

FIG. 2 illustrates an example in which the pixel electrode PE is in the form of a flat plate, but the structure of the pixel electrode PE is not particularly limited. That is, in another example, the pixel electrode PE may have one or more slits. In still another example, one or more pixel electrodes PE may be disposed in each pixel, in which case, the pixel electrodes PE may be provided with different voltages.

A second substrate 1000 may be disposed to face the first substrate 500.

The second substrate 1000 may be formed of a material having heat resistance and transparency. The second substrate 1000 may be formed of, for example, transparent glass or plastic, but the present disclosure is not limited thereto.

An overcoat film OC may be disposed on the second substrate 1000. The overcoat film OC may comprise an organic insulating material or an inorganic insulating material. The overcoat film OC may be formed on the entire surface of the second substrate 1000 and may serve as a planarization film. FIG. 3 illustrates an example in which the overcoat film OC has a single-layer structure, but the present disclosure is not limited thereto. That is, in another example, the overcoat film OC may have a multilayer structure including two or more films. In another example, the overcoat film OC may not be provided.

A common electrode CE may be disposed on the overcoat film OC. The common electrode CE may be a non-patterned front electrode. A common voltage may be applied to the common electrode CE. In response to the common electrode CE and the pixel electrode PE being supplied with different voltages, an electric field may be uniformly formed between the common electrode CE and the pixel electrode PE.

A liquid crystal layer LC may be disposed between the first and second substrates 500 and 1000, and a plurality of liquid crystal molecules may be disposed in the liquid crystal layer LC. The liquid crystal layer LC may be controlled by the electric field formed between the common electrode CE and the pixel electrode PE, and light for displaying an image can be controlled by controlling the motion of the liquid crystal molecules in the liquid crystal layer LC.

FIG. 3 illustrates an example in which the common electrode CE is formed on the second substrate 1000, but the present disclosure is not limited thereto. In another example, the common electrode CE may be formed on the first substrate 500. That is, in an exemplary embodiment, the display device may be a plane-to-line switching (PLS) liquid crystal display (LCD) device.

Referring again to FIG. 1, the seal pattern SLP may be disposed in the non-display area NDA. The seal pattern SLP may be disposed between the first and second substrates 500 and 1000 and may bond the first and second substrates 500 and 1000 together.

The seal pattern SLP may be disposed to surround the display area DA. In an exemplary embodiment, the seal pattern SLP may have a closed figure shape.

In an exemplary embodiment, the seal pattern SLP may have a circular shape, a polygonal shape, or a shape with straight lines and curves mixed therein in a plan view.

In an exemplary embodiment, the seal pattern SLP may be disposed in a direction parallel to an x axis and/or a y axis. Also, in an exemplary embodiment, the seal pattern SLP may include bent portions, which extend in diagonal directions.

In an exemplary embodiment, the bent portions of the seal pattern SLP may be disposed in corner areas F1.

The non-display area NDA may include one or more corner areas F1. In an exemplary embodiment where the display device is rectangular in shape, the display device may have four corner areas F1.

The corner areas F1 may be disposed adjacent to the corners of the display area DA. The cross-sectional shape of the corner areas F1 will hereinafter be described with reference to FIG. 4.

Referring to FIG. 4, a corner area F1 may include a first insulating film ILD1, the first color filter CF_1, the second color filter CF_2, the first organic film 104, the second organic film 105, and the seal pattern SLP, which are disposed on the first substrate 500.

The first insulating film ILD1 may be an organic insulating film or an inorganic insulating film. The first insulating film ILD1 may extend from the display area DA and may be formed of the same material as the gate insulating film GI and/or the buffer layer 101 of the display area DA.

FIG. 4 illustrates an example in which the first insulating film ILD1 has a single-layer structure, but the structure of the first insulating film ILD1 is not particularly limited. In an exemplary embodiment, the first insulating film ILD1 may have at least one of a stack of a plurality of organic insulating films, a stack of a plurality of inorganic insulating films, and a stack of an organic insulating film and an inorganic insulating film.

In another exemplary embodiment, the first insulating film ILD1 may not be provided.

The first color filter CF_1 may be disposed on the first insulating film ILD1. The first color filter CF_1 may extend from the display area DA.

In an exemplary embodiment, the first color filter CF_1 may be a red color filter.

The first color filter CF_1 may partially cover the corner area F1. In other words, the first color filter CF_1 may at least partially expose the first insulating film ILD1.

The second color filter CF_2 may be disposed on the first color filter CF_1. In an exemplary embodiment, the second color filter CF_2 may cover the first color filter CF_1 and the first insulating film ILD1.

The second color filter CF_2 may extend from the display area DA. In an exemplary embodiment, the second color filter CF_2 may be a blue color filter.

The first organic film 104 may be disposed on the second color filter CF_2. The first organic film 104 may be formed of an organic insulating material. The first organic film 104 may comprise an organic insulating material such as, for example, BCB, an acrylic material, and PI.

In an exemplary embodiment, the first organic film 104 may be formed of the same material as the second passivation film 103 in the display area DA. In other words, the first organic film 104 and the second passivation film 103 may be formed at the same time by the same process, but the present disclosure is not limited thereto. That is, alternatively, the first organic film 104 and the second passivation film 103 may be formed independently of each other by different processes.

The second organic film 105 may be disposed on the first organic film 104. The second organic film 105 may partially cover the first organic film 104.

The second organic film 105 may be formed of an organic insulating material. In an exemplary embodiment, the second organic film 105 may comprise a colored pigment. In a case where the second organic film 105 comprises a colored pigment, the second organic film 105 can suppress the reflection of external light in the non-display area NDA.

In an exemplary embodiment, a plurality of column spacers (not illustrated) may be disposed between the first and second substrates 500 and 1000 to maintain a cell gap. In an exemplary embodiment, the second organic film 105 may be formed of the same material as the column spacers.

The seal pattern SLP may be disposed on the second organic film 105. In an exemplary embodiment, the seal pattern SLP may overlap with the second color filter CF_2, the first organic film 104, and the second organic film 105. The seal pattern SLP may not overlap with the first color filter CF_1.

The second substrate 1000, which faces the first substrate 500, may be disposed on the seal pattern SLP. The overcoat film OC may be disposed on the second substrate 1000.

As described above, the first and second substrates 500 and 1000 may be bonded together by the seal pattern SLP.

The liquid crystal layer LC may be disposed on the inside of the seal pattern SLP.

The height from the first organic film 104 and/or the second organic film 105 to the second substrate 1000 will hereinafter be described.

For convenience of explanation, some terms will be defined first.

First, second, and third points P1, P2, and P3 may be defined on the inside of the seal pattern SLP (particularly, between the seal pattern SLP and the display area DA).

The first point P1 may be defined as a point where the second color filter CF_2, the first organic film 104, and the second organic film 105 overlap with one another.

The second point P2 may be defined as a point where the first color filter CF_1, the second color filter CF_2, the first organic film 104, and the second organic film 105 overlap with one another.

The third point P3 may be defined as a point where the first color filter CF_1, the second color filter CF_2, and the first organic film 104 overlap with one another.

A first height h1 may be defined as the distance between the first point P1 and the top of the liquid crystal layer LC. A second height h2 may be defined as the distance between the second point P2 and the top of the liquid crystal layer LC. A third height h3 may be defined as the distance between the third point P3 and the top of the liquid crystal layer LC, may be defined.

In an exemplary embodiment, the first, second, and third heights h1, h2, and h3 may be substantially the same.

FIG. 4 illustrates an example in which the first, second, and third heights h1, h2, and h3 are all the same, but the present disclosure is not limited thereto. Although not specifically illustrated, various wires or electrode patterns may be disposed on the first substrate 500 and may thus cause the first, second, and third heights h1, h2, and h3 to differ from one another.

In another exemplary embodiment, the difference between the maximum and the minimum among the first, second, and third heights h1, h2, and h3 may be 0.2 μm or less.

The liquid crystal layer LC may be disposed between the seal pattern SLP and the display area DA, i.e., on the inside of the seal pattern SLP. If the seal pattern SLP has a large height difference, the liquid crystal layer LC may not be properly injected in an area adjacent to the seal pattern SLP, thereby causing a display defect.

As described above, in a case where the seal pattern SLP is formed to overlap with at least one color filter, any height difference on the inside of the seal pattern SLP can be reduced, and as a result, the liquid crystal layer LC can be uniformly injected even in the area adjacent to the seal pattern SLP.

Display devices according to other exemplary embodiments will hereinafter be described. In FIGS. 4 through 6, like reference numerals indicate like elements, and thus, detailed descriptions thereof will be omitted.

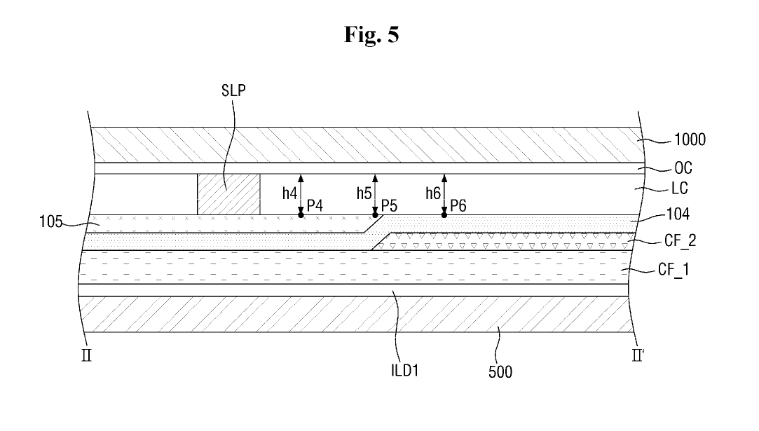

FIG. 5 is a cross-sectional view of a display device according to another exemplary embodiment.

The display device of FIG. 5 differs from the display device of FIG. 4 in that a seal pattern SLP overlaps a first color filter CF_1 but the seal pattern SLP does not overlap a second color filter CF_2.

Referring to FIG. 5, the first color filter CF_1 may be formed on a first insulating film ILD1. The first color filter CF_1 may extend to overlap with the seal pattern SLP.

The second color filter CF_2 may be formed on the first color filter CF_1. The second color filter CF_2 may partially cover the first color filter CF_1 and may not overlap with the seal pattern SLP.

A first organic film 104 may be disposed on the second color filter CF_2. The first organic film 104 may cover the first and second color filters CF_1 and CF_2. That is, in an exemplary embodiment, the first organic film 104 may be placed in contact with both the first and second color filters CF_1 and CF_2.

A second organic film 105 may be disposed on the first organic film 104. The second organic film 105 may partially cover the first organic film 104 and may at least partially expose the top surface of the first organic film 104.

The seal pattern SLP may be formed on the second organic film 105. The seal pattern SLP may overlap with the first color filter CF_1 and the first and second organic films 104 and 105.

Fourth, fifth, and sixth points P4, P5, and P6 may be defined on the inside of the seal pattern SLP.

The fourth point P4 may be defined as a point where the first color filter CF_1, the first organic film 104, and the second organic film 105 overlap with one another.

The fifth point P5 may be defined as a point where the first color filter CF_1, the second color filter CF_2, the first organic film 104, and the second organic film 105 overlap with one another.

The sixth point P6 may be defined as a point where the first color filter CF_1, the second color filter CF_2, and the first organic film 104 overlap with one another.

A fourth height h4 may be defined as the distance between the fourth point P4 and the top of a liquid crystal layer LC. A fifth height h5 may be defined as the distance between the fifth point P5 and the top of the liquid crystal layer LC. A sixth height h6 may be defined as the distance between the sixth point P6 and the top of the liquid crystal layer LC.

In an exemplary embodiment, the fourth, fifth, and sixth heights h4, h5, and h6 may be substantially the same.

In another exemplary embodiment, the difference between the maximum and the minimum among the fourth, fifth, and sixth heights h4, h5, and h6 may be 0.2 μm or less.

The liquid crystal layer LC may be disposed between the seal pattern SLP and a display area DA, i.e., on the inside of the seal pattern SLP. If the seal pattern SLP has a large height difference, the liquid crystal layer LC may not be properly injected in an area adjacent to the seal pattern SLP, thereby causing a display defect.

As described above, in a case where the seal pattern SLP is formed to overlap with at least one color filter, any height difference on the inside of the seal pattern SLP can be reduced, and as a result, the liquid crystal layer LC can be uniformly injected even in the area adjacent to the seal pattern SLP.

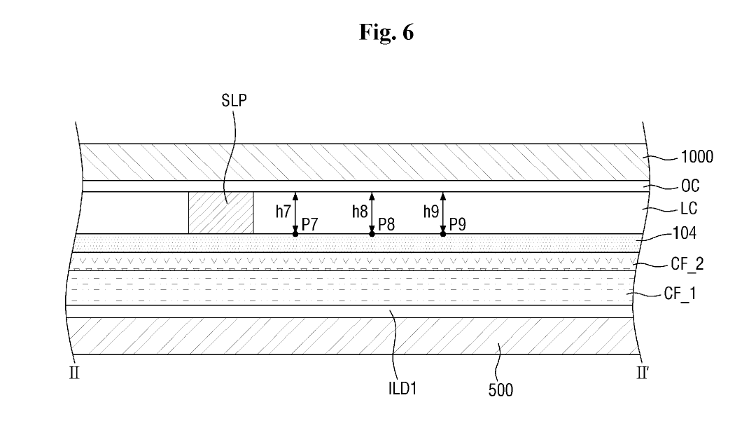

FIG. 6 is a cross-sectional view of a display device according to another exemplary embodiment.

The display device of FIG. 6 differs from the display device of FIG. 4 in that a seal pattern SLP overlaps the first and second color filters CF_1 and CF_2.

Referring to FIG. 6, in an exemplary embodiment, the first color filter CF_1 and the second color filter CF_2, which covers the first color filter CF_1, may be disposed on a first substrate 500.

A first organic film 104 may be disposed on the second color filter CF_2.

The seal pattern SLP may be disposed on the first organic film 104. In an exemplary embodiment, the seal pattern SLP may overlap with the first and second color filters CF_1 and CF_2 and the first organic film 104.

In an exemplary embodiment, a second organic film 105 may not be provided.

In this exemplary embodiment, since the first and second color filters CF_1 and CF_2 and the first organic film 104 are uniformly disposed on the first substrate 500, three arbitrary points on the first substrate 500, i.e., seventh, eighth, and ninth points P7, P8, and P9, may all be defined as points where the first and second color filters CF_1 and CF_2 and the first organic film 104 overlap with one another.

A seventh height h7 may be defined as the distance between the seventh point P7 and the top of a liquid crystal layer LC. An eighth height h8 may be defined as the distance between the eighth point P8 and the top of the liquid crystal layer LC. A ninth height h9 may be defined as the distance between the ninth point P9 and the top of the liquid crystal layer LC.

In an exemplary embodiment, the seventh, eighth, and ninth heights h7, h8, and h9 may be substantially the same.

In another exemplary embodiment, the difference between the maximum and the minimum among the seventh, eighth, and ninth heights h7, h8, and h9 may be 0.2 μm or less.

The liquid crystal layer LC may be disposed between the seal pattern SLP and a display area DA, i.e., on the inside of the seal pattern SLP. If the seal pattern SLP has a large height difference, the liquid crystal layer LC may not be properly injected in an area adjacent to the seal pattern SLP, thereby causing a display defect.

As described above, in a case where the seal pattern SLP is formed to overlap with at least one color filter, any height difference on the inside of the seal pattern SLP can be reduced, and as a result, the liquid crystal layer LC can be uniformly injected even in the area adjacent to the seal pattern SLP.

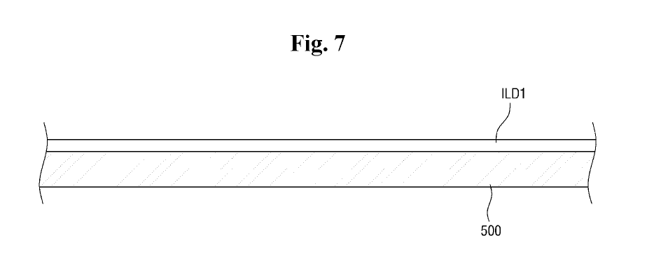

A method of manufacturing a display device according to an exemplary embodiment will hereinafter be described. In FIGS. 7 through 11, like reference numerals indicate like elements, and thus, detailed descriptions thereof will be omitted.

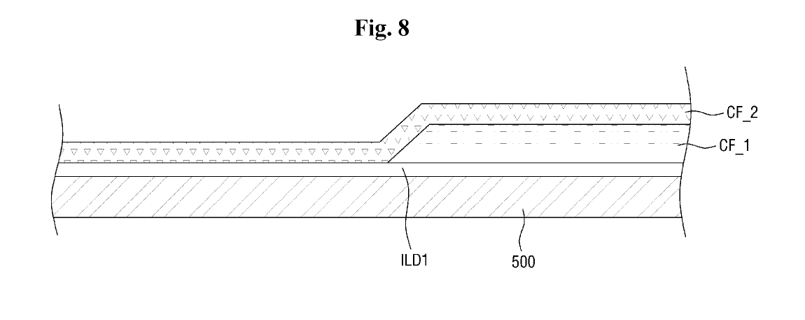

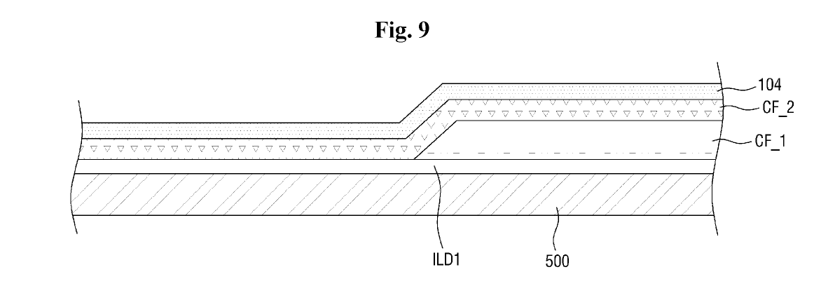

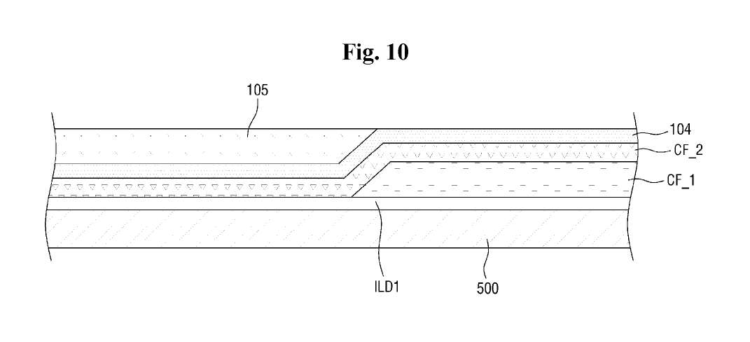

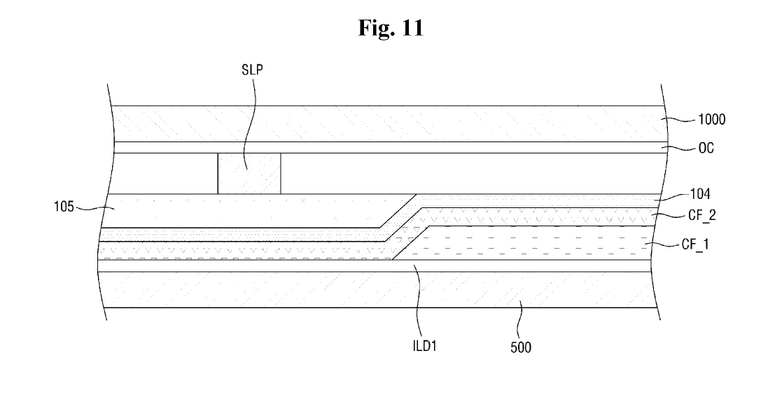

FIG. 7, FIG. 8, FIG. 9, FIG. 10, and FIG. 11 are cross-sectional views illustrating a method of manufacturing a display device according to an exemplary embodiment.

Referring to FIGS. 7 through 11, the method includes: forming a first color filter CF_1 in a non-display area NDA of a first substrate 500 on which a display area DA and the non-display area NDA are both defined; forming a second color filter CF_2 on the first color filter CF_1; and forming a first organic film 104 on the second color filter CF_2.

Referring first to FIG. 7, the step of preparing the first substrate 500 may be performed. The first substrate 500 may be substantially the same as the first substrate 500 of any one of the display devices according to the above-described exemplary embodiments. That is, the display area DA and the non-display area NDA may both be defined on the first substrate 500, and FIG. 7 illustrates the non-display area NDA.

A first insulating film ILD1 may be formed on the first substrate 500. The first insulating film ILD1 may be formed by any one selected from among, for example, chemical vapor deposition (CVD), sputtering, and nozzle printing, but the present disclosure is not limited thereto.

Referring to FIG. 8, the steps of forming the first color filter CF_1 on the first substrate 500 and forming the second color filter CF_2 on the first color filter CF_1 may be performed.

In an exemplary embodiment, the first color filter CF_1 may be a red color filter. The first color filter CF_1 may partially cover the first insulating film ILD1, but the present disclosure is not limited thereto. That is, alternatively, the first color filter CF_1 may completely cover the first insulating film ILD1.

Thereafter, the step of forming the second color filter CF_2 on the first color filter CF_1 may be performed.

The second color filter CF_2 may cover the first color filter CF_1 and the first insulating film ILD1.

In an exemplary embodiment where the first color filter CF_1 partially covers the first insulating film ILD1, the second color filter CF_2 may be placed in contact with the first insulating film ILD1 and the first color filter CF_1.

Thereafter, referring to FIG. 9, the step of forming the first organic film 104 on the second color filter CF_2 may be performed.

The first organic film 104 may be formed by, for example, CVD.

In an exemplary embodiment, the first organic film 104 may be performed together with, and by the same process as, a second passivation film 103 in the display area DA.

Thereafter, referring to FIG. 10, the step of forming a second organic film 105 on the first organic film 104 may be performed.

The second organic film 105 may comprise a colored pigment and may partially cover the first organic film 104.

Thereafter, referring to FIG. 11, the steps of forming a seal pattern SLP on the first substrate 500 and bonding the first substrate 500 and a second substrate 1000 may be performed.

The seal pattern SLP may be formed to overlap with at least one of the first and second color filters CF_1 and CF_2.

FIG. 11 illustrates an example in which the seal pattern SLP overlaps with the second color filter CF_2, but the present disclosure is not limited thereto. That is, in another example, the seal pattern SLP may overlap with the first color filter CF_1, as illustrated in FIG. 5, or may overlap with both the first and second color filters CF_1 and CF_2, as illustrated in FIG. 6.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device, comprising:
a first substrate on which a display area and a non-display area disposed outside the display area are defined;
a second substrate facing the first substrate;
a liquid crystal layer disposed between the first and second substrates;
a first color filter disposed in the non-display area;
a second color filter disposed on the first color filter;
a first organic film disposed on the second color filter; and
a seal pattern formed on the first organic film and overlapping with at least one of the first and second color filters.

2. The display device of claim 1, further comprising:
a second organic film formed on the first organic film and comprising a colored pigment.

3. The display device of claim 2, wherein the seal pattern overlaps with the second organic film.

4. The display device of claim 2, wherein:
a first point is defined where the second organic film, the first organic film, and the second color filter overlap with one another on the inside of the seal pattern,
a second point is defined where the second organic film, the first organic film, the second color filter, and the first color filter overlap with one another on the inside of the seal pattern, and
a third point is defined where the first organic film, the second color filter, and the first color filter overlap with one another on the inside of the seal pattern.

5. The display device of claim 4, wherein:
a first height is defined as a distance between the first point and a top of the liquid crystal layer,
a second height is defined as a distance between the second point and the top of the liquid crystal layer,
a third height is defined as a distance between the third point and the top of the liquid crystal layer, and
a difference between a maximum and a minimum among the first, second, and third heights is 0.2 μm or less.

6. The display device of claim 5, wherein the first, second, and third heights are all the same.

7. The display device of claim 1, wherein the seal pattern overlaps with the first and second color filters.

8. The display device of claim 7, wherein:
a first point and a second point are defined as where the first color filter, the second color filter, and the first organic film overlap with one another on the inside of the seal pattern, and
a difference between a first height, which is a distance between the first point and a top of the liquid crystal layer, and a second height, which is a distance between the second point and the top of the liquid crystal layer, is 0.2 μm or less.

9. The display device of claim 8, wherein the first height is the same as the second height.

10. The display device of claim 1, wherein:
the first color filter is a red color filter, and
the second color filter is a blue color filter.

11. The display device of claim 1, wherein:
the first color filter is a blue color filter, and
the second color filter is a red color filter.

12. The display device of claim 1, wherein the first color filter, the second color filter, the first organic film, and the seal pattern are formed at a corner area of the non-display area.

13. A method of manufacturing a display device, comprising:
forming a first color filter in a non-display area of a first substrate on which a display area and the non-display area are defined;
forming a second color filter on the first color filter;
forming a first organic film on the second color filter;
forming a seal pattern on the first organic film; and
bonding the first substrate and a second substrate that faces the first substrate,
wherein the seal pattern overlaps with at least one of the first and second color filters.

14. The method of claim 13, further comprising:
forming a second organic film, which comprises a colored pigment, on the first organic film.

15. The method of claim 14, wherein the seal pattern overlaps with the second organic film.

16. The method of claim 15, wherein:
a first point is defined as where the second organic film, the first organic film, and the second color filter overlap with one another on the inside of the seal pattern,
a second point is defined as where the second organic film, the first organic film, the second color filter, and the first color filter overlap with one another on the inside of the seal pattern, and
a third point is defined as where the first organic film, the second color filter, and the first color filter overlap with one another on the inside of the seal pattern.

17. The method of claim 16, wherein:
a liquid crystal layer is disposed between the first and second substrates,
a first height is defined as a distance between the first point and a top of the liquid crystal layer,
a second height is defined as a distance between the second point and the top of the liquid crystal layer,
a third height is defined as a distance between the third point and the top of the liquid crystal layer, and
a difference between a maximum and a minimum among the first, second, and third heights is 0.2 μm or less.

18. The method of claim 17, wherein the first, second, and third heights are all the same.

19. The method of claim 13, wherein:
the first color filter is a red color filter, and
the second color filter is a blue color filter.

20. The method of claim 13, wherein:
the first color filter is a blue color filter, and
the second color filter is a red color filter.
